(19) United States
(12) Patent Application Publication
(10) Pub. No.: US 2023/0122950 A1
(43) Pub. Date: Apr. 20, 2023

(54) COVERAGE ENHANCEMENT FOR DOWNLINK BROADCAST CHANNEL

(71) Applicant: QUALCOMM Incorporated, San Diego, CA (US)

(72) Inventors: Chao WEI, Beijing (CN); Jing LEI, San Diego, CA (US); Huilin XU, Temecula, CA (US); Wanshi CHEN, San Diego, CA (US); Peter Pui Lok ANG, San Diego, CA (US); Hwan Joon KWON, San Diego, CA (US); Hung Dinh LY, San Diego, CA (US); Peter GAAL, San Diego, CA (US)

(21) Appl. No.: 17/904,796

(22) PCT Filed: Mar. 11, 2020
(86) PCT No.: PCT/CN2020/078741

§ 371 Date: Aug. 23, 2022

(51) Int. Cl. H04W 72/30; H04W 72/232; H04W 72/0446; H04L 5/00

(52) U.S. Cl. CPC H04W 72/30; H04W 72/232; H04W 72/0446; H04L 5/0012

(57) ABSTRACT

This disclosure provides systems, methods and apparatus, including computer programs encoded on computer storage media, for configuring and signaling repetition transmissions of broadcast system information on downlink (DL) channels. In some implementations, a user equipment (UE) may receive an indication of a repetition configuration for broadcast information carried on a physical downlink shared channel (PDSCH), may identify a number of slots configured to carry the broadcast information on the PDSCH based at least in part on the repetition configuration, and may receive the broadcast information carried on the PDSCH in the number of identified slots.

### TECHNICAL FIELD

This disclosure relates generally to wireless communications and, more specifically, to broadcast transmissions employing coverage enhancement techniques.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems (such as a Long Term Evolution (LTE) system or a Fifth Generation (5G) New Radio (NR) system). A wireless multiple-access communications system may include a number of base stations or access network nodes, each simultaneously supporting communication for multiple communication devices, which may be otherwise known as user equipment (UE).

These multiple access technologies have been adopted in various telecommunication standards to provide a common protocol that enables different wireless devices to communicate on a municipal, national, regional, and even global level. An example telecommunication standard is 5G NR, which is part of a continuous mobile broadband evolution promulgated by the Third Generation Partnership Project (3GPP) to meet new requirements associated with latency, reliability, security, scalability, and other requirements. 5G NR includes services associated with enhanced mobile broadband (eMBB), massive machine type communications (mMTC), and ultra-reliable low latency communications (URLLC). There exists a need for further improvements in 5G NR technology. These improvements also may be applicable to other multi-access technologies and the telecommunication standards that employ these technologies.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for wireless communication. The method may be performed by a user equipment (UE), and may include receiving downlink control information (DCI) indicating a repetition configuration for broadcast information carried on a physical downlink shared channel (PDSCH), identifying a number of slots configured to carry the broadcast information on the PDSCH based at least in part on the repetition configuration, and receiving the broadcast information carried on the PDSCH in the number of identified slots. The broadcast information may include a first system information block (SIB1), and the repetition configuration may include a bitmap identifying slots within a transmission period of the SIB1 that are available for repetition. The bitmap may include a number N of bits, with each bit of the N bits indicating a corresponding slot of N slots available for repetition transmission. In some instances, the bitmap may be replicated one or more times to identify one or more additional sets of N slots available for repetition transmissions of the SIB 1. In other instances, only the first M slots of the available slots are used for repetition transmissions, where the value of M may be based on the number of available slots. In some implementations, the method may also include receiving the repetition of the SIB1 in one or more of the number of slots identified by the bitmap.

Another innovative aspect of the subject matter described in this disclosure can be implemented in a user equipment (UE). The UE may include one or more processors coupled to a memory. The memory may store instructions that, when executed by the one or more processors, cause the UE to perform a number of operations. In some implementations, the number of operations may include receiving downlink control information (DCI) indicating a repetition configuration for broadcast information carried on a physical downlink shared channel (PDSCH), identifying a number of slots configured to carry the broadcast information on the PDSCH based at least in part on the repetition configuration, and receiving the broadcast information carried on the PDSCH in the number of identified slots. The broadcast information may include a first system information block (SIB1), and the repetition configuration may include a bitmap identifying slots within a transmission period of the SIB1 that are available for repetition. The bitmap may include a number N of bits, with each bit of the N bits indicating a corresponding slot of N slots available for repetition transmission. In some instances, the bitmap may be replicated one or more times to identify one or more additional sets of N slots available for repetition transmissions of the SIB 1. In other instances, only the first M slots of the available slots are used for repetition transmissions, where the value of M may be based on the number of available slots. In some implementations, the method may also include receiving the repetition of the SIB1 in one or more of the number of slots identified by the bitmap.

Another innovative aspect of the subject matter described in this disclosure can be implemented as a method for wireless communication. The method may be performed by a user equipment (UE), and may include receiving an indication of a frequency hopping pattern for a physical downlink shared channel (PDSCH) carrying broadcast information, and receiving the broadcast information on the PDSCH based on the frequency hopping pattern. In some implementations, the broadcast information may include a first system information block (SIB1), and each frequency hopping offset of the number of frequency hopping offsets may be based on a size of a common control resource set with index 0 (CORESET #0) allocated to the PDSCH. In some other implementations, the broadcast information may include one or more of a paging signal or a random access response (RAR), and each frequency hopping offset of the number of frequency hopping offsets may be configured by a SIB carried on the PDSCH. In addition, or in the alternative, the indication may identify a number of frequency hopping offsets for the frequency hopping pattern.

In some implementations, the method may also include receiving an indication of a number of slots configured for the PDSCH carrying the broadcast information, determining slot-specific frequency hopping offsets based at least in part on the identified number of slots, and receiving the broadcast information carried in the number of identified slots based at least in part on the frequency hopping pattern and the slot-specific frequency hopping offsets. In some instances, the slot-specific frequency hopping offsets may include a first frequency hopping offset for even-numbered slots of the number of identified slots, and may include a second frequency hopping offset for odd-numbered slots of the number of identified slots. In some aspects, the indication may be received in a downlink control information (DCI) message.

In some other implementations, the method may also include receiving a synchronization signal block (SSB) on a beam transmitted by a base station, determining a frequency hopping offset based at least in part on the received SSB, and receiving the broadcast information carried on the PDSCH via the beam based at least in part on the frequency hopping pattern and the frequency hopping offset. The method may also include receiving a downlink control information (DCI) message indicating whether a bandwidth part (BWP) associated with the SSB is shifted by the frequency hopping offset. In some instances, the frequency hopping offset may be semi-statically configured via radio resource control (RRC) signaling. The RRC signaling may indicate a mapping between a plurality of beams associated with the base station and a number of frequency hopping offsets.

Another innovative aspect of the subject matter described in this disclosure can be implemented in a user equipment (UE). The UE may include one or more processors coupled to a memory. The memory may store instructions that, when executed by the one or more processors, cause the UE to perform a number of operations. In some implementations, the number of operations may include receiving an indication of a frequency hopping pattern for a physical downlink shared channel (PDSCH) carrying broadcast information, and receiving the broadcast information on the PDSCH based on the frequency hopping pattern. In some implementations, the broadcast information may include a first system information block (SIB1), and each frequency hopping offset of the number of frequency hopping offsets may be based on a size of a common control resource set with index 0 (CORESET #0) allocated to the PDSCH. In some other implementations, the broadcast information may include one or more of a paging signal or a random access response (RAR), and each frequency hopping offset of the number of frequency hopping offsets may be configured by a SIB carried on the PDSCH. In addition, or in the alternative, the indication may identify a number of frequency hopping offsets for the frequency hopping pattern.

In some implementations, the number of operations may also include receiving an indication of a number of slots configured for the PDSCH carrying the broadcast information, determining slot-specific frequency hopping offsets based at least in part on the identified number of slots, and receiving the broadcast information carried in the number of identified slots based at least in part on the frequency hopping pattern and the slot-specific frequency hopping offsets. In some instances, the slot-specific frequency hopping offsets may include a first frequency hopping offset for even-numbered slots of the number of identified slots, and may include a second frequency hopping offset for odd-numbered slots of the number of identified slots. In some aspects, the indication may be received in a downlink control information (DCI) message.

In some other implementations, the number of operations may also include receiving a synchronization signal block (SSB) on a beam transmitted by a base station, determining a frequency hopping offset based at least in part on the received SSB, and receiving the broadcast information carried on the PDSCH via the beam based at least in part on the frequency hopping pattern and the determined frequency hopping offset. The number of operations may also include receiving a downlink control information (DCI) message indicating whether a bandwidth part (BWP) associated with the SSB is shifted by the frequency hopping offset. In some instances, the frequency hopping offset may be semi-statically configured via radio resource control (RRC) signaling. The RRC signaling may indicate a mapping between a plurality of beams associated with the base station and a number of frequency hopping offsets.

Another innovative aspect of the subject matter described in this disclosure can be implemented as a method for wireless communication. The method may be performed by a user equipment (UE), and may include transmitting a random access preamble sequence to a base station, receiving a physical downlink control channel (PDCCH) scheduling a physical downlink shared channel (PDSCH) within a number of consecutive slots, receiving a random access response (RAR) from the base station in one or more slots of the number of consecutive slots of the PDSCH, the RAR including a random access preamble identifier, and transmitting a radio resource control (RRC) connection setup message to the base station based at least in part on the received RAR. In some instances, the PDSCH may be associated with a transport block size (TBS) scaling factor of one-eighth.

In some implementations, each of the number of consecutive slots of the PDSCH may be associated with a different transport block (TB), and a start of the RRC connection setup message transmission may be based on a last symbol period in the slot of the PDSCH carrying the RAR. In some other implementations, the number of consecutive slots of the PDSCH may be aggregated slots associated with the same TB, and a start of the RRC connection setup message transmission may be based on a last symbol period of the aggregated slots.

In some implementations, the method may also include comparing an index of the random access preamble identifier with an index of the random access preamble sequence, and skipping a decoding of the RAR in the subsequent slots based on the comparing. In some instances, skipping the decoding may include refraining from decoding the RAR when the index of the random access preamble identifier is larger than the index of the random access preamble sequence, and continuing decoding the RAR when the index of the random access preamble identifier is not larger than the index of the random access preamble sequence. In other instances, skipping the decoding may include refraining from decoding the RAR when the index of the random access preamble identifier is in a different group from the index of the random access preamble sequence, and continuing decoding the RAR when the index of the random access preamble identifier is in a same group as the index of the random access preamble sequence.

Another innovative aspect of the subject matter described in this disclosure can be implemented in a user equipment (UE). The UE may include one or more processors coupled to a memory. The memory may store instructions that, when executed by the one or more processors, cause the UE to perform a number of operations. In some implementations, the number of operations may include transmitting a random access preamble sequence to a base station, receiving a physical downlink control channel (PDCCH) scheduling a physical downlink shared channel (PDSCH) within a number of consecutive slots, receiving a random access response (RAR) from the base station in one or more slots of the number of consecutive slots of the PDSCH, the RAR including a random access preamble identifier, and transmitting a radio resource control (RRC) connection setup message to the base station based at least in part on the received RAR. In some instances, the PDSCH may be associated with a transport block size (TBS) scaling factor of one-eighth.

In some implementations, each of the number of consecutive slots of the PDSCH may be associated with a different transport block (TB), and a start of the RRC connection setup message transmission may be based on a last symbol period in the slot of the PDSCH carrying the RAR. In some other implementations, the number of consecutive slots of the PDSCH may be aggregated slots associated with the same TB, and a start of the RRC connection setup message transmission may be based on a last symbol period of the aggregated slots.

In some implementations, the number of operations may also include comparing an index of the random access preamble identifier with an index of the random access preamble sequence, and skipping a decoding of the RAR in the subsequent slots based on the comparing. In some instances, skipping the decoding may include refraining from decoding the RAR when the index of the random access preamble identifier is larger than the index of the random access preamble sequence, and continuing decoding the RAR when the index of the random access preamble identifier is not larger than the index of the random access preamble sequence. In other instances, skipping the decoding may include refraining from decoding the RAR when the index of the random access preamble identifier is in a different group from the index of the random access preamble sequence, and continuing decoding the RAR when the index of the random access preamble identifier is in a same group as the index of the random access preamble sequence.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a diagram illustrating an example wireless communications system.

FIGS. 2A-2D show an example 5G NR frame, example downlink (DL) channels within a 5G NR slot, another example 5G NR frame, and example uplink (UL) channels within a 5G NR slot, respectively.

FIG. 3 shows a diagram illustrating an example base station and user equipment (UE) in an access network.

FIG. 4A shows a sequence diagram illustrating an example message exchange between a base station and a UE according to some implementations.

FIG. 4B shows an example repetition configuration usable for broadcast DL transmissions according to some implementations.

FIGS. 5A-5B show sequence diagrams illustrating example message exchanges between a base station and a UE according to some implementations.

FIG. 5C shows an example inter-SSB frequency hopping pattern usable for broadcast DL transmissions according to some implementations.

FIG. 5D shows an example inter-slot frequency hopping pattern usable for broadcast DL transmissions according to some implementations.

FIG. 6A shows a sequence diagram illustrating an example message exchange between a base station and a UE according to some implementations.

FIG. 6B shows an illustration depicting an example scheduling of multiple transport blocks usable for broadcast DL transmissions according to some implementations.

FIG. 6C shows an illustration depicting an example scheduling of repetition slots usable for broadcast DL transmissions according to some implementations.

FIG. 7 shows a flowchart depicting an example operation for wireless communication that supports repetition of broadcast information.

FIG. 8 shows a flowchart depicting an example operation for wireless communication that supports repetition of broadcast information.

FIG. 9 shows a flowchart depicting an example operation for wireless communication that supports frequency hopping on a downlink channel carrying broadcast information.

FIGS. 10A-10C show flowcharts depicting example operations for wireless communication that supports frequency hopping on a downlink channel carrying broadcast information.

FIG. 11 shows a flowchart depicting an example operation for wireless communication that supports repetition transmissions for a random access procedure.

FIGS. 12A-12C show flowchart depicting example operations for wireless communication that supports repetition transmissions for a random access procedure.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Long Term Evolution (LTE), 3G, 4G or 5G (New Radio (NR)) standards promulgated by the 3rd Generation Partnership Project (3GPP), the Institute of Electrical and Electronics Engineers (IEEE) 802.11 standards, the IEEE 802.15 standards, or the Bluetooth® standards as defined by the Bluetooth Special Interest Group (SIG), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless wide area network (WWAN), a wireless personal area network (WPAN), a wireless local area network (WLAN), or an internet of things (IOT) network.

Some UEs may have limited capabilities for receiving DL transmissions. For example, limited capability or low capability (LC) UEs may include only one antenna, and may not be able to receive more than one broadcast TB in a given slot. Additionally, the BWP size of LC UEs is relatively small as compared with higher-performance UEs (such as eMBB and URLLC devices). To compensate for the reduced service coverage of LC UEs, coverage enhancement techniques have been introduced that enable LC UEs to transmit and receive data in a radio access network over longer distances and at lower power levels. Coverage enhancement techniques may include repetition within subframes, repetition across different subframes, power boosting, beamforming, and spatial multiplexing. Different coverage enhancement techniques may result in different coverage trade-offs. For example, repetition of data over multiple subframes may improve range and/or reception reliability, but it may also decrease the data rates. Boosting the transmission power may also increase range and/or reception reliability, but it may increase energy use and cause interference with other transmissions.

Although repetition and slot aggregation may be effective in providing coverage enhancement for unicast DL transmissions, they may be problematic when applied to DL transmissions that include broadcast information. For example, while unicast DL transmissions may be bundled or repeated in consecutive slots of one or more subframes, using slot aggregation or transmission repetition techniques for DL channels carrying certain broadcast information may not be resource-efficient, for example, because high-performance UEs or LC UEs close to a base station may not need repetition or slot aggregation for receiving broadcast information. Moreover, when the PDSCH carries SIB1, which contains the initial frame synchronization information needed for UEs to locate the UL and DL channels of a serving cell (as well as cell access and scheduling information for SIB2), repetition of the SIB1 in consecutive slots of a radio frame may not be feasible. More specifically, because some of the slots in TDD frames may be configured for UL transmissions (rather than DL transmissions), one or more consecutive slots of a radio frame selected for repetition may be configured for UL transmissions, and therefore may not be available for repetition of SIB1 transmissions. However, because repetition configurations are typically indicated to UEs via RRC signaling, they are not very well suited for broadcast information transmitted on a DL channel (such as the PDSCH).

In accordance with some aspects of the present disclosure, a repetition configuration for broadcast information transmitted on the PDSCH may be indicated in a DCI message, rather than via RRC signaling, which may allow a base station to dynamically signal and/or modify repetition configurations for DL broadcast information. In some instances, the number of slots available for repetition may be based at least in part on a modulation and coding scheme (MCS) used by a UE or a group of UEs. For example, a relatively small number of slots may be used for repetition when the MCS used by a UE (or a group of UEs) is relatively low, and a relatively large number of slots may be used for repetition when the MCS used by the UE (or the group of UEs) is relatively high. In some implementations, the DCI message may include a bitmap that identifies a number of slots that are available for repetition. In some instances, the bitmap may identify a number of consecutive slots in a radio frame that are available for repetition. In some other instances, the bitmap may identify a number of slots within a transmission period of the SIB1 that are available for repetition.

Repetition may also be used to provide coverage enhancement for LC UEs during random access procedures. In some implementations, the base station may transmit a PDCCH scheduling a PDSCH within a number of consecutive slots of a radio frame. When a UE transmits a random access preamble sequence to the base station on the RACH, the base station may respond by transmitting a random access response (RAR) in one or more of the consecutive slots of the PDSCH. By repetitively transmitting the RAR in one or more consecutive slots of the PDSCH, the LC UE may use portions of the RAR received in subsequent slots of the PDSCH to supplement or reconstruct portions of the RAR that were not received or correctly decoded in previous slots of the PDSCH, thereby increasing the likelihood of the LC UE completing the RACH procedure and thereafter establishing a RRC connection with the base station.

In some implementations, frequency hopping techniques may be employed for DL transmissions of broadcast information from a base station to reduce interference from other devices, for example, by exploiting the frequency diversity of a wireless medium. The frequency hopping techniques may also increase channel access because there may be less contention on relatively small frequency bands (such as the hopping channels associated with a frequency hopping pattern) than on relatively large frequency bands (such as primary channels used in wideband communications). In some implementations, the base station may provide an indication of a frequency hopping pattern for the PDSCH carrying broadcast information. The indication may be transmitted from the base station to one or more UEs in a DCI message, and may allow each of the one or more UEs to receive the broadcast information on the PDSCH based on the frequency hopping pattern. In some instances, the indication may identify a number of frequency hopping offsets. For example, the broadcast information may include a first system information block (SIB1), and each frequency hopping offset may be based on a size of a common control resource set with index 0 (CORESET #0) allocated to the PDSCH. For another example, the broadcast information may include one or more of a paging signal or a RAR, and each frequency hopping offset may be configured by a system information block (SIB) carried on the PDSCH.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

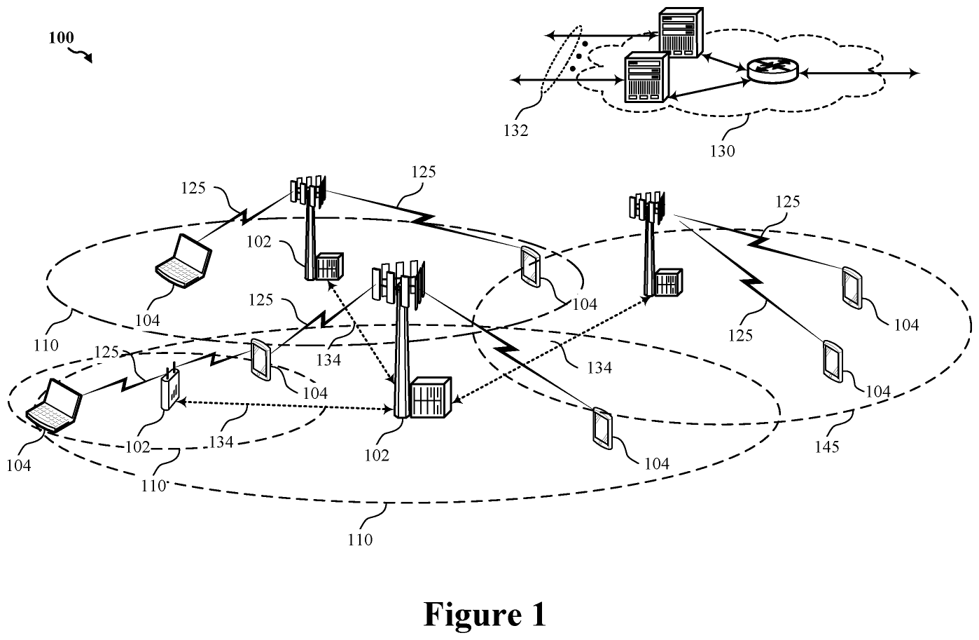

FIG. 1 shows a diagram of an example wireless communications system 100 and an access network. The wireless communications system 100 includes base stations 102, UEs 104, and a core network 130. In some examples, the wireless communications system 100 may be a Long Term Evolution (LTE) network, an LTE-Advanced (LTE-A) network, an LTE-A Pro network, or a New Radio (NR) network. In some implementations, wireless communications system 100 may support enhanced broadband communications, ultra-reliable (e.g., mission critical) communications, low latency communications, or communications with low-cost and low-complexity devices.

Base stations 102 may wirelessly communicate with UEs 104 via one or more base station antennas. Base stations 102 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 102 of different types (e.g., macro or small cell base stations, and so on). The UEs 104 described herein may be able to communicate with various types of base stations 102 and network equipment including macro eNBs, small cell eNBs, gNBs, relay base stations, and the like.

Each base station 102 may be associated with a particular coverage area 110 in which communications with various UEs 104 are supported. Each base station 102 may provide communication coverage for a respective coverage area 110 via communication links 125, and communication links 125 between a base station 102 and a UE 104 may utilize one or more carriers. Communication links 125 shown in wireless communications system 100 may include uplink transmissions from a UE 104 to a base station 102, or downlink transmissions from a base station 102 to a UE 104. Downlink transmissions may also be called forward link transmissions while uplink transmissions may also be called reverse link transmissions.

The geographic coverage area 110 for a base station 102 may be divided into sectors making up only a portion of the geographic coverage area 110, and in some implementations, each sector may be associated with a cell. For example, each base station 102 may provide communication coverage for a macro cell, a small cell, a hot spot, or other types of cells, or various combinations thereof. In some examples, a base station 102 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 102 or by different base stations 102. The wireless communications system 100 may include, for example, a heterogeneous LTE/LTE-A/LTE-A Pro or NR network in which different types of base stations 102 provide coverage for various geographic coverage areas 110.

The term “cell” refers to a logical communication entity used for communication with a base station 102 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some implementations, the term “cell” may refer to a portion of a geographic coverage area 110 (e.g., a sector) over which the logical entity operates.

UEs 104 may be dispersed throughout the wireless communications system 100, and each UE 104 may be stationary or mobile. A UE 104 may also be referred to as a mobile device, a wireless device, a remote device, a handheld device, or a subscriber device, or some other suitable terminology, where the “device” may also be referred to as a unit, a station, a terminal, or a client. A UE 104 may also be a personal electronic device such as a cellular phone, a personal digital assistant (PDA), a tablet computer, a laptop computer, or a personal computer. In some examples, a UE 104 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 104, such as MTC or IoT devices, may be low cost or low complexity (LC) devices, and may provide for automated communication between machines (e.g., via Machine-to-Machine (M2M) communication). M2M communication or MTC may refer to data communication technologies that allow devices to communicate with one another or a base station 102 without human intervention. In some examples, M2M communication or MTC may include communications from devices that integrate sensors or meters to measure or capture information and relay that information to a central server or application program that can make use of the information or present the information to humans interacting with the program or application. Some UEs 104 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 104 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 104 include entering a power saving “deep sleep” mode when not engaging in active communications, or operating over a limited bandwidth (e.g., according to narrowband communications). In some implementations, UEs 104 may be designed to support critical functions (e.g., mission critical functions), and a wireless communications system 100 may be configured to provide ultra-reliable communications for these functions.

In some implementations, a UE 104 may also be able to communicate directly with other UEs 104 (e.g., using a peer-to-peer (P2P) or device-to-device (D2D) protocol). One or more of a group of UEs 104 utilizing D2D communications may be within the geographic coverage area 110 of a base station 102. Other UEs 104 in such a group may be outside the geographic coverage area 110 of a base station 102, or be otherwise unable to receive transmissions from a base station 102. In some implementations, groups of UEs 104 communicating via D2D communications may utilize a one-to-many (1:M) system in which each UE 104 transmits to every other UE 104 in the group. In some implementations, a base station 102 facilitates the scheduling of resources for D2D communications. In other cases, D2D communications are carried out between UEs 104 without the involvement of a base station 102.

Base stations 102 may communicate with the core network 130 and with one another. For example, base stations 102 may interface with the core network 130 through backhaul links 132 (e.g., via an S1, N2, N3, or another interface). Base stations 102 may communicate with one another over backhaul links 134 (e.g., via an X2, Xn, or other interface) either directly (e.g., directly between base stations 102) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 104 served by base stations 102 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 102, may include subcomponents such as an access network entity, which may be an example of an access node controller (ANC). Each access network entity may communicate with UEs 104 through a number of other access network transmission entities, which may be referred to as a radio head, a smart radio head, or a transmission/reception point (TRP). In some configurations, various functions of each access network entity or base station 102 may be distributed across various network devices (e.g., radio heads and access network controllers) or consolidated into a single network device (e.g., a base station 102).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 104 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 104 and base stations 102, and EHF antennas of the respective devices may be even smaller and more closely spaced than UHF antennas. In some implementations, this may facilitate use of antenna arrays within a UE 104. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some implementations, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 102 and UEs 104 may employ listen-before-talk (LBT) procedures to ensure a frequency channel is clear before transmitting data. In some implementations, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 102 or UE 104 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 102) and a receiving device (e.g., a UE 104), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 102 or a UE 104) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 102 may use multiple antennas or antenna arrays to conduct beamforming operations for directional communications with a UE 104. For instance, some signals (e.g., synchronization signals, reference signals, beam selection signals, or other control signals) may be transmitted by a base station 102 multiple times in different directions, which may include a signal being transmitted according to different beamforming weight sets associated with different directions of transmission. Transmissions in different beam directions may be used to identify (e.g., by the base station 102 or a receiving device, such as a UE 104) a beam direction for subsequent transmission and/or reception by the base station 102. Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based at least in in part on a signal that was transmitted in different beam directions. For example, a UE 104 may receive one or more of the signals transmitted by the base station 102 in different directions, and the UE 104 may report to the base station 102 an indication of the signal it received with a highest signal quality, or an otherwise acceptable signal quality. Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104), or transmitting a signal in a single direction (e.g., for transmitting data to a receiving device).

A receiving device (e.g., a UE 104, which may be an example of a mmW receiving device) may try multiple receive beams when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some implementations, the antennas of a base station 102 or UE 104 may be located within one or more antenna arrays, which may support MIMO operations, or transmit or receive beamforming. For example, one or more base station antennas or antenna arrays may be co-located at an antenna assembly, such as an antenna tower. In some implementations, antennas or antenna arrays associated with a base station 102 may be located in diverse geographic locations. A base station 102 may have an antenna array with a number of rows and columns of antenna ports that the base station 102 may use to support beamforming of communications with a UE 104. Likewise, a UE 104 may have one or more antenna arrays that may support various MIMO or beamforming operations.

In some implementations, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some implementations perform packet segmentation and reassembly to communicate over logical channels. A Media Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 104 and a base station 102 or core network 130 supporting radio bearers for user plane data. At the Physical (PHY) layer, transport channels may be mapped to physical channels.

In some implementations, UEs 104 and base stations 102 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some implementations, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Ts= 1/30,720,000 seconds. Time intervals of a communications resource may be organized according to radio frames each having a duration of 10 milliseconds (ms), where the frame period may be expressed as Tf=307,200 Ts. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some implementations, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some aspects, a symbol of a mini-slot or a mini-slot may be the smallest unit of scheduling. Each symbol may vary in duration depending on the subcarrier spacing or frequency band of operation, for example.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 104. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 104 may be configured for operating over portions or all of the carrier bandwidth. In other examples, some UEs 104 may be configured for operation using a narrowband protocol type that is associated with a predefined portion or range (e.g., set of subcarriers or RBs) within a carrier (e.g., “in-band” deployment of a narrowband protocol type).

In some implementations, a carrier may be subdivided into portions, each portion having a smaller bandwidth than the carrier bandwidth (e.g., 100 MHz), and such portions may be referred to as bandwidth parts or BWPs. For example, some devices (e.g., some UEs 104) may not support the full bandwidth of a carrier, and thus may communicate using one or more BWPs. In some implementations, a UE 104 may establish communications with a base station 102 using a first BWP, which may be referred to as an initial BWP, and the UE 104 may thereafter switch to a different BWP. In some implementations, BWPs may be paired or otherwise grouped. For example, a UE 104 may communicate using paired or grouped uplink and downlink BWPs (e.g., in an FDD implementation). Further, in some implementations a UE 104 that switches to a different BWP may switch (e.g., concurrently or simultaneously or as part of a single BWP-switching operation) from a first pair or other group of BWPs to a second pair or other group BWPs.

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 104 receives and the higher the order of the modulation scheme, the higher the data rate may be for the UE 104. In MIMO systems, a wireless communications resource may refer to a combination of a radio frequency spectrum resource, a time resource, and a spatial resource (e.g., spatial layers), and the use of multiple spatial layers may further increase the data rate for communications with a UE 104.

Devices of the wireless communications system 100 (e.g., base stations 102 or UEs 104) may have a hardware configuration that supports communications over a particular carrier bandwidth, or may be configurable to support communications over one of a set of carrier bandwidths. In some examples, the wireless communications system 100 may include base stations 102 and/or UEs 104 that can support simultaneous communications via carriers associated with more than one different carrier bandwidth.

Wireless communications system 100 may support communication with a UE 104 on multiple cells or carriers, a feature which may be referred to as carrier aggregation (CA) or multi-carrier operation. A UE 104 may be configured with multiple downlink CCs and one or more uplink CCs according to a carrier aggregation configuration. Carrier aggregation may be used with both FDD and TDD component carriers.

In some implementations, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some implementations, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 104 that are not capable of monitoring the whole carrier bandwidth or are otherwise configured to use a limited carrier bandwidth (e.g., to conserve power).

In some implementations, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 104 or base station 102 utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some implementations, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

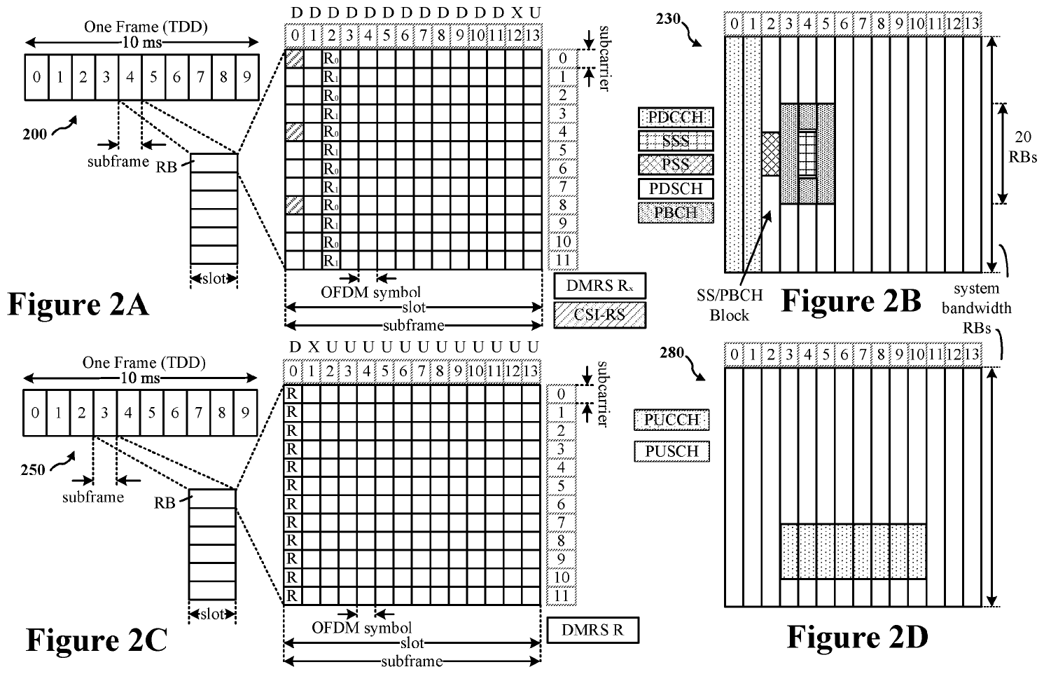

FIG. 2A shows an example of a first slot 200 within a 5G NR frame structure. FIG. 2B shows an example of DL channels 230 within a 5G NR slot. FIG. 2C shows an example of a second slot 250 within a 5G NR frame structure. FIG. 2D shows an example of UL channels 280 within a 5G NR slot. In some instances, the 5G NR frame structure may be FDD in which, for a particular set of subcarriers (carrier system bandwidth), slots within the set of subcarriers are dedicated for either DL or UL transmissions. In some other instances, the 5G NR frame structure may be TDD in which, for a particular set of subcarriers (carrier system bandwidth), slots within the set of subcarriers are dedicated for both DL and UL transmissions. In the examples shown in FIGS. 2A and 2C, the 5G NR frame structure is based on TDD, with slot 4 configured with slot format 28 (with mostly DL), where D indicates DL, U indicates UL, and X indicates that the slot is flexible for use between DL and UL, and with slot 3 configured with slot format 34 (with mostly UL). While slots 3 and 4 are shown with slot formats 34 and 28, respectively, any particular slot may be configured with any of the various available slot formats 0-61. Slot formats 0 and 1 are all DL and all UL, respectively. Other slot formats 2-61 include a mix of DL, UL, and flexible symbols. UEs may be configured with the slot format, either dynamically through downlink control information (DCI) or semi-statically through radio resource control (RRC) signaling by a slot format indicator (SFI). The configured slot format also may apply to a 5G NR frame structure that is based on FDD.

Other wireless communication technologies may have a different frame structure or different channels. A frame may be divided into a number of equally sized subframes. For example, a frame having a duration of 10 milliseconds (ms) may be divided into 10 equally sized subframes each having a duration of 1 ms. Each subframe may include one or more time slots. Subframes also may include mini-slots, which may include 7,4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (such as for high throughput scenarios) or discrete Fourier transform (DFT) spread OFDM (DFT-s-OFDM) symbols (also referred to as single carrier frequency-division multiple access (SC-FDMA) symbols) (such as for power limited scenarios).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology there are 14 symbols per slot and 2μ slots per subframe. The subcarrier spacing and symbol length/duration are a function of the numerology. The subcarrier spacing may be equal to 2\hat{ }μ*15 kHz, where μ is the numerology 0 to 5. As such, the numerology μ=0 has a subcarrier spacing of 15 kHz, and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 microseconds (p).

A resource grid may be used to represent the frame structure. Each time slot includes a resource block (RB) (also referred to as a physical RB (PRB)) that extends across 12 consecutive subcarriers and across a number of symbols. The intersections of subcarriers and across 14 symbols. The intersections of subcarriers and of the RB define multiple resource elements (REs). The number of bits carried by each RE depends on the modulation scheme.

As illustrated in FIG. 2A, some of the REs carry a reference signal (RS) for the UE. In some configurations, one or more REs may carry a demodulation reference signal (DM-RS) (indicated as Rx for one particular configuration, where 100× is the port number, but other DM-RS configurations are possible). In some configurations, one or more REs may carry a channel state information reference signal (CSI-RS) for channel measurement at the UE. The REs also may include a beam measurement reference signal (BRS), a beam refinement reference signal (BRRS), and a phase tracking reference signal (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe or symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

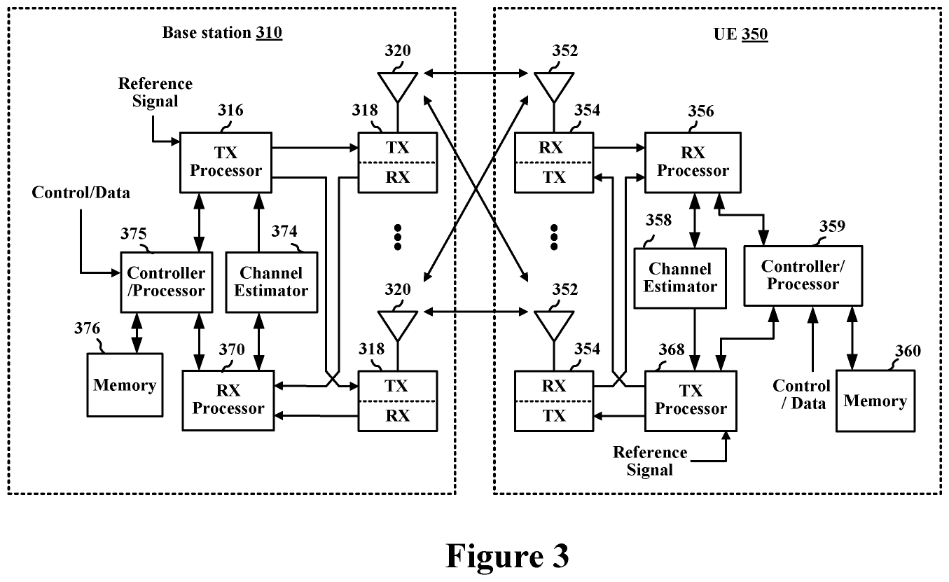

FIG. 3 shows a block diagram of an example base station 310 and UE 350 in an access network. In the DL, IP packets from a EPC may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as the MIB and SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (such as a pilot signal) in the time or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as the MIB and SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC. The controller/processor 375 is also responsible for error detection using an ACK or NACK protocol to support HARQ operations. Information to be wirelessly communicated (such as for LTE or NR based communications) is encoded and mapped, at the PHY layer, to one or more wireless channels for transmission.

In the example of FIG. 3, each antenna 352 of the UE 350 is coupled to a respective transmitter 354TX. However, in some other implementations, the UE 350 may include fewer transmitters (or transmit chains) than receive (RX) antennas. Although not shown for simplicity, each transmitter may be coupled to a respective power amplifier (PA) which amplifies the signal to be transmitted. The combination of a transmitter and a PA may be referred to herein as a “transmit chain” or “TX chain.” To save on cost or die area, the same PA may be reused to transmit signals over multiple RX antennas. In other words, one or more TX chains of a UE may be selectively coupled to multiple RX antennas ports.

Some UEs may have limited capabilities for receiving DL transmissions. For example, limited capability or low capability (LC) UEs may include only one antenna, may not be able to receive more than one broadcast TB in a given slot. Additionally, the BWP size of LC UEs is relatively small as compared with higher-performance UEs (such as eMBB and URLLC devices). To compensate for the reduced service coverage of LC UEs, coverage enhancement techniques have been introduced that enable LC UEs to transmit and receive data in a radio access network over longer distances and at lower power levels. Coverage enhancement techniques may include repetition within subframes, repetition across different subframes, power boosting, beamforming, and spatial multiplexing. Different coverage enhancement techniques may result in different coverage trade-offs. For example, repetition of data over multiple subframes may improve range and/or reception reliability, but it may also decrease the data rates. Boosting the transmission power may also increase range and/or reception reliability, but it may increase energy use and cause interference with other transmissions.

Although repetition and slot aggregation may be effective in providing coverage enhancement for unicast DL transmissions, they may be problematic when applied to DL transmissions that include broadcast information. For example, while unicast DL transmissions may be bundled or repeated in consecutive slots of one or more subframes, using slot aggregation or transmission repetition techniques for DL channels carrying certain broadcast information may not be resource-efficient, for example, because high-performance UEs or LC UEs close to a base station may not need repetition or slot aggregation for receiving broadcast information. Moreover, when the PDSCH carries SIB1, which contains the initial frame synchronization information needed for UEs to locate the UL and DL channels of a serving cell (as well as cell access and scheduling information for SIB2), repetition of the SIB1 in consecutive slots of a radio frame may not be feasible. More specifically, because some of the slots in TDD frames may be configured for UL transmissions (rather than DL transmissions), one or more consecutive slots of a radio frame selected for repetition may be configured for UL transmissions, and therefore may not be available for repetition of SIB1 transmissions. However, because repetition configurations are typically indicated to UEs via RRC signaling, they are not very well suited for broadcast information transmitted on a DL channel (such as the PDSCH).

In accordance with some aspects of the present disclosure, a repetition configuration for broadcast information transmitted on the PDSCH may be indicated in a DCI message, rather than via RRC signaling, which may allow a base station to dynamically signal and/or modify repetition configurations for DL broadcast information. In some instances, the number of slots available for repetition may be based at least in part on a modulation and coding scheme (MCS) used by a UE or a group of UEs. For example, a relatively small number of slots may be used for repetition when the MCS used by a UE (or a group of UEs) is relatively low, and a relatively large number of slots may be used for repetition when the MCS used by the UE (or the group of UEs) is relatively high. In some implementations, the DCI message may include a bitmap that identifies a number of slots that are available for repetition. In some instances, the bitmap may identify a number of consecutive slots in a radio frame that are available for repetition. In some other instances, the bitmap may identify a number of slots within a transmission period of the SIB1 that are available for repetition.

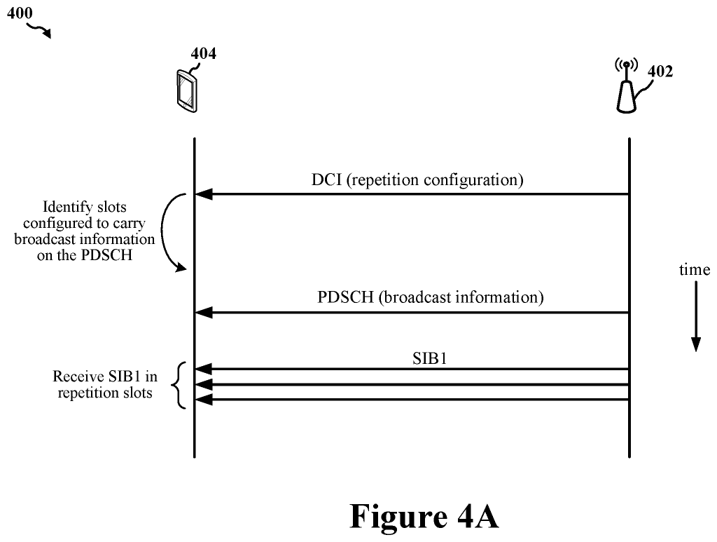

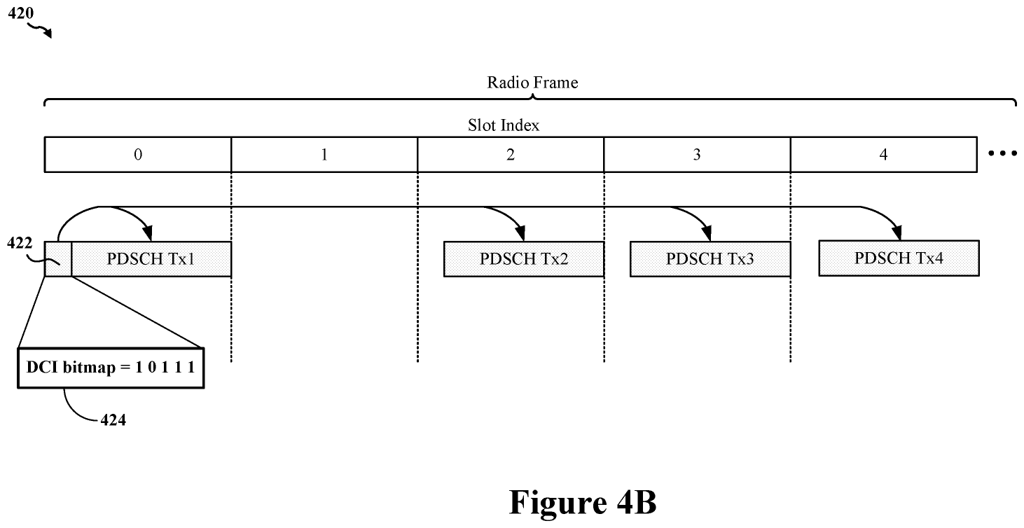

FIG. 4A shows a sequence diagram illustrating an example message exchange 400 between a base station 402 and a UE 404 in a radio access network (RAN). The base station 402 may be one example of the base station 102 of FIG. 1 or the base station 310 of FIG. 3, and the UE 404 may be one example of the UE 104 of FIG. 1 or the UE 350 of FIG. 3. The base station 402 may be any suitable base station or node including, for example, a gNB or an eNB. The RAN may be any suitable radio access network, and may utilize any suitable radio access technologies. In some implementations, the access network may be a 5G NR communication system.

The base station 402 transmits downlink control information (DCI) indicating a repetition configuration for broadcast information carried on a physical downlink shared channel (PDSCH). The repetition configuration may indicate or identify a number of slots configured for repetition transmission of the broadcast information. In some aspects, the repetition configuration may provide coverage enhancement for UEs having limited capabilities, for example, as provided by one or more NR-light technical specifications. The UE 404 receives the DCI, and decodes the repetition configuration to identify the slots for repetition transmission of the broadcast information.

The base station 402 transmits the broadcast information on the PDSCH in multiple slots according to the repetition configuration. In some instances, the UE 404 may receive all of the broadcast information carried in the initial transmission, and may not need repetition transmission of the broadcast information. In other instances, the UE 404 may receive only a portion (or none) of the broadcast information carried in the initial transmission, and may receive the remaining portions of the broadcast information in one or more of the repetition transmission slots of the PDSCH. In this manner, a UE having limited capabilities (such as an eMTC or LC UE) that is unable to receive and correctly decode all of the broadcast information carried in the initial PDSCH transmission may receive additional portions of the broadcast information carried in the repetition slots.

In some implementations, the broadcast information may include a SIB1 containing access information (such as cell identity information, cell selection and reselection information) and scheduling information for other SIBs. The repetition configuration carried in the DCI transmit may include a bitmap that identifies slots within a transmission period of the SIB1 that are available for repetition transmission of broadcast information from the base station 402. The bitmap may include a number N of bits, with each bit of the N bits indicating a corresponding slot of N slots available for repetition transmission. In some instances, the bitmap may be replicated one or more times to identify one or more additional sets of N slots available for repetition transmission of SIB1 on the PDSCH. In other instances, only the first M slots of the identified available slots are used by the base station 402 for repetition transmissions. The value of M may be based on the number of slots configured for repetition transmission of the broadcast information.

FIG. 4B shows an example repetition configuration 420 usable for broadcast DL transmissions according to some implementations. In some implementations, the repetition configuration 420 may be indicated in a DCI message 422 containing a bitmap 424. For the example of FIG. 4B, the DCI bitmap 424 includes five bits b₀—b₄, where b₀=1, b₁=0, b₂=1, b₃=1, and b₄=1. Referring also to FIG. 4A, the DCI message 422 may be transmitted to a UE on a DL channel (such as the PDCCH), and the DCI bitmap 424 may identify a number of slots within a SIB1 transmission period (such as 20 ms) that are configured to carry repetitions of broadcast information on the PDSCH, where a bit value of “0” indicates that a corresponding slot of the SIB1 transmission period is not configured for repetitions of broadcast information on the PDSCH, and a bit value of “1” indicates that the corresponding slot of the SIB1 transmission period is configured for repetitions of broadcast information on the PDSCH. In some instances, the first bit b₀ may be set to “1,” for example, because the corresponding slot (slot 0) of the SIB1 transmission period is used for the initial or original transmission of the broadcast information on the PDSCH.

Thus, for the example of FIG. 4B, the first bit b₀=1 indicates that the first slot of the SIB1 transmission period is configured for an initial broadcast information transmission, the second bit b₁=0 indicates that the second slot of the SIB1 transmission period is not configured for broadcast information repetitions, the third bit b₂=1 indicates that the third slot of the SIB1 transmission period is configured for broadcast information repetitions, the fourth bit b₃=1 indicates that the fourth slot of the SIB1 transmission period is configured for broadcast information repetitions, and the fifth bit b₄=1 indicates that the fifth slot of the SIB1 transmission period is configured for broadcast information repetitions.

In other implementations, the slots indicated for repetition by the DCI bitmap may be identified relative to the PDCCH slot that carries the DCI message. For example, the first bit b₀ may correspond to the PDCCH slot that carries the DCI message, the second bit b₁ may correspond to the next slot in the SIB1 transmission period, the third bit b₂ may correspond to the next slot in the SIB1 transmission period, and so on. In some other implementations, the DCI bitmap 424 may include other numbers of bits of any suitable value.

A base station (not shown for simplicity) may transmit the DCI message 422 to a UE (not shown for simplicity) to indicate the repetition configuration for DL broadcast transmissions on the PDSCH. The UE may receive the DCI message 422, decode the bitmap 424, and identify slots 0, 2, 3, and 4 of the radio frame as configured to carry broadcast information repetitions on the PDSCH. Based on the bitmap 424, the UE may receive (if necessary) repetition transmissions of the broadcast information in slots 2, 3, and 4 of the radio frame. In this manner, the repetition configuration for DL broadcast transmissions on the PDSCH may be indicated to one or more UEs by the DCI message 424, for example, rather than RRC signaling, and may therefore be dynamically signaled and/or modified by the base station.

In some implementations, the DCI bitmap 424 includes a number N of bits, with each bit of the N bits indicating a corresponding slot of N slots available for repetition transmissions (where N is an integer greater than one), as depicted in FIG. 4B. In some instances, only the first M slots of the identified available slots are used for repetition transmissions, wherein M is an integer less than N. In addition, or in the alternative, the DCI bitmap 424 may be replicated one or more times to identify one or more additional sets of N slots available for repetition transmissions of the SIB 1. In some other implementations, the DCI bitmap 424 may identify a number of slots within a transmission period of the SIB1 that are available for repetition.

The frequency diversity of a wireless medium or channel may be exploited by frequency hopping across a set of frequency resources or hopping channels according to a frequency hopping pattern. The frequency hopping pattern for a broadcast channel may be based on a set of hopping parameters configured by the network. The hopping parameters may include, for example, a hopping enable flag, one or more hopping offsets, the number and order of hopping channels to hop, and a hopping duration. In some aspects, the hopping parameters for broadcast channel hopping may be independently configured by the network, and the base station may communicate the hopping parameter configuration information to the UEs using RRC signaling. In some other aspects, the hopping parameters for broadcast channel hopping may be the same or based on the hopping parameters defined in a SIB.

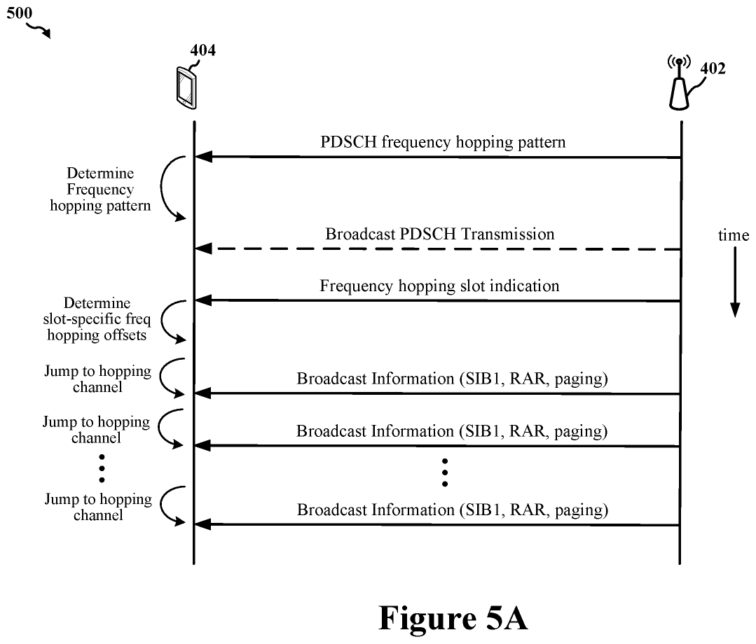

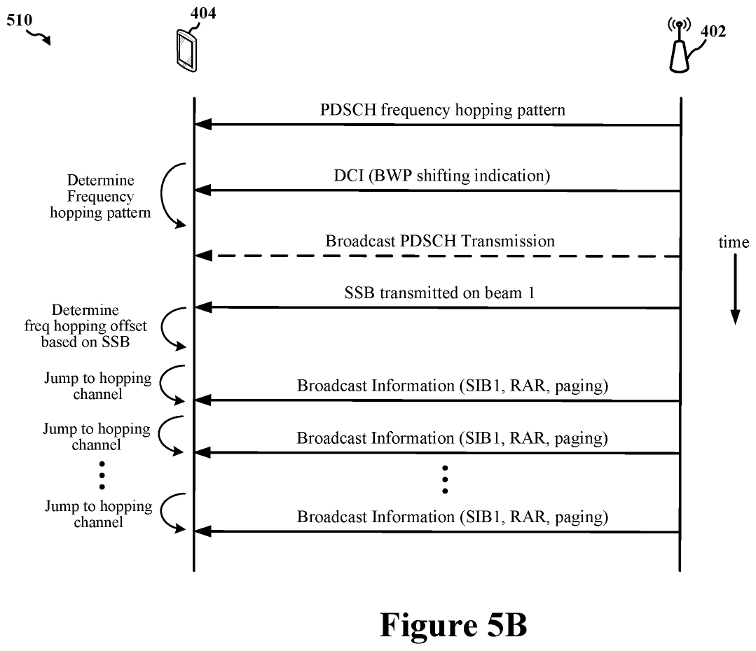

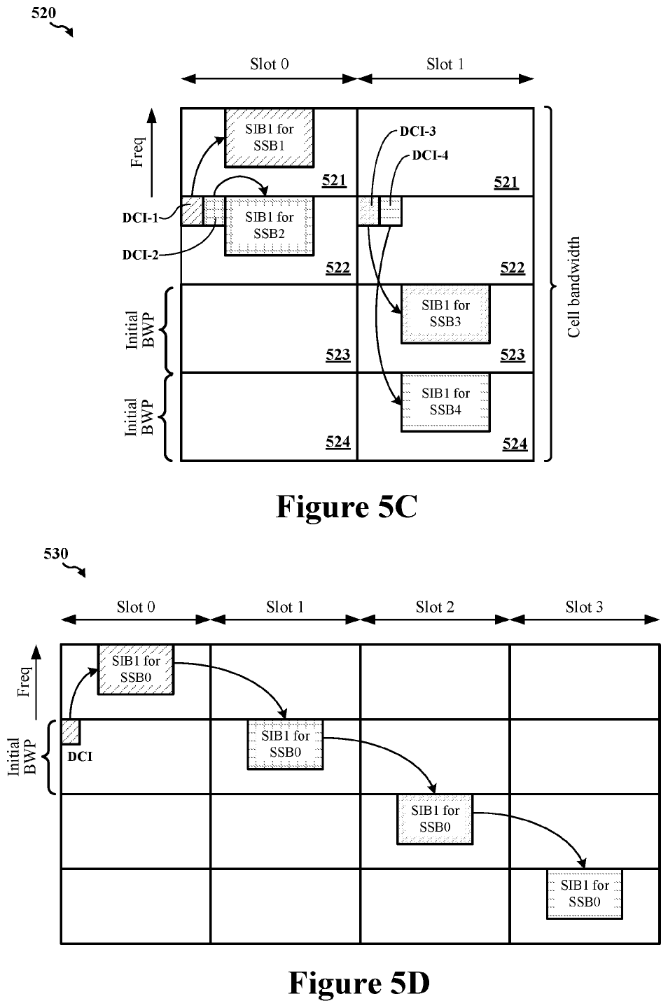

FIG. 5A shows a sequence diagram illustrating an example message exchange 500 between a base station 402 and a UE 404 in a radio access network (RAN). The base station 402 may be one example of the base station 102 of FIG. 1 or the base station 310 of FIG. 3, and the UE 404 may be one example of the UE 104 of FIG. 1 or the UE 350 of FIG. 3. The base station 402 may be any suitable base station or node including, for example, a gNB or an eNB. The RAN may be any suitable radio access network, and may include any suitable radio access technology. network a 5G NR communication system. In some implementations, the base station 402 and UE 404 may use frequency hopping to exploit frequency diversity.

The base station 402 may select or determine a frequency hopping pattern for transmitting broadcast information to one or more UEs, and transmits an indication of the frequency hopping pattern for the PDSCH that carries the broadcast information. In some implementations, the indication may also include or indicate a number of frequency hopping offsets associated with the frequency hopping pattern. The base station 402 may transmit indications of the frequency hopping pattern and the frequency hopping offsets in any suitable manner. In some instances, the base station 402 may transmit the indications to the UE 404 in the DCI.

The UE 404 receives the PDSCH transmission, and determines the frequency hopping pattern and the corresponding frequency hopping offsets configured for the broadcast PDSCH. The UE 404 may then receive the broadcast information carried on the PDSCH according to the indicated frequency hopping pattern. In some instances, the UE 404 may receive all of the broadcast information carried in the initial transmission, and may not need repetition transmission of the broadcast information. In other instances, the UE 404 may receive only a portion (or none) of the broadcast information carried by the initial broadcast PDSCH, and may receive the remaining portions of the broadcast information on one or more hopping channels of the frequency hopping pattern.

In some implementations, the broadcast information may include a first system information block (SIB1), and the frequency hopping offsets may be based on a size of a common control resource set with index 0 (CORESET #0) allocated to the PDSCH. In other implementations, the broadcast information may include a paging signal or a random access response (RAR), and the frequency hopping offsets may be configured by the SIB.

In some other implementations, the base station 402 may indicate a number of slots configured for the PDSCH carrying the broadcast information. The slot indications may be transmitted in a broadcast PDSCH transmission, or may be provided to the UE 404 in one or more DCI messages. The UE 404 receives one or more of the indications provided by the base station 402, and may determine a number of slot-specific frequency hopping offsets based on the indications received from the base station 402. In some instances, the slot-specific frequency hopping offsets may include a first frequency hopping offset for the even-numbered slots configured for carrying the broadcast information, and may include a second frequency hopping offset for the odd-numbered slots configured for carrying the broadcast information.

FIG. 5B shows a sequence diagram illustrating another example message exchange 510 between the base station 402 and the UE 404. The base station 402 may select or determine a frequency hopping pattern for transmitting broadcast information to one or more UEs, and transmits an indication of the frequency hopping pattern for the PDSCH on a particular beam of a plurality of beams available to the base station 402. The base station 402 may also transmit one or more DCI messages indicating whether a bandwidth part (BWP) associated with the SSB is shifted by the frequency hopping offset. If BWP shifting is indicated for a SSB, the UE can receive all subsequent broadcast PDSCH transmissions on the shifted BWP based on the indicated frequency hopping offset. If BWP shifting is not indicated, the frequency hopping pattern is used only for the scheduled PDSCH carrying broadcast information. That is, BWP shifting is used only for the indicated SSB; the BWP is not shifted for the other non-indicated SSBs. In some implementations, BWP shifting can also be applied to UL transmissions such as, for example, the UL BWP used for transmitting the PRACH. The UE 404 receives the PDSCH transmission, and determines the frequency hopping pattern for the PDSCH carrying broadcast information. The UE 404 may then receive broadcast PDSCH transmissions based on the indicated frequency hopping pattern.

The base station 402 may also transmit a synchronization signal block (SSB) on the particular beam. The SSB may indicate, among other information not discussed herein for simplicity, one or more frequency hopping offsets associated with the frequency hopping pattern. In some implementations, the frequency hopping offsets may be based at least in part on the SSB associated with the particular beam. The frequency hopping offsets may be semi-statically configured via radio resource control (RRC) signaling. In some aspects, the RRC signaling may indicate a mapping between a plurality of beams associated with the base station and a number of frequency hopping offsets.

In some instances, the UE 404 may receive all of the broadcast information carried in the initial transmission, and may not need repetition transmission of the broadcast information. In other instances, the UE 404 may receive only a portion (or none) of the broadcast information carried by the initial broadcast PDSCH, and may receive the remaining portions of the broadcast information on one or more hopping channels of the frequency hopping pattern.

FIG. 5C shows an example inter-SSB frequency hopping pattern 520 usable for broadcast DL transmissions according to some implementations. The inter-SSB frequency hopping pattern 520 may be used to assign broadcast PDSCH transmissions associated with different beams or SSBs of a base station to different frequency bands or hopping channels of one or more frequency hopping patterns. In some implementations, SSB-specific frequency hopping offsets may be used to ensure that broadcast PDSCH transmissions on different beams or associated with different SSBs do not share frequency hopping channels (which would result in collisions). For the example of FIG. 5C, the SIB1 for each of SSB1-SSB4 may be transmitted on four distinct non-overlapping frequency hopping channels by using SSB-specific frequency hopping offsets. That is, the frequency hopping offset associated with a first beam may be based on SSB1, the frequency hopping offset associated with a second beam may be based on SSB2, the frequency hopping offset associated with a third beam may be based on SSB3, and the frequency hopping offset associated with a fourth beam may be based on SSB4.

Specifically, a first DCI message DCI-1 may signal or trigger the DL transmission of SIB1 for SSB1 using first frequency resources 521 of slot 0, and a second DCI message DCI-2 may signal or trigger the DL transmission of SIB1 for SSB2 using second frequency resources 522 of slot 0. A third DCI message DCI-3 may signal or trigger the DL transmission of SIB1 for SSB3 using third frequency resources 521 of slot 1, and a fourth DCI message DCI-4 may signal or trigger the DL transmission of SIB1 for SSB4 using fourth frequency resources 524 of slot 1.

FIG. 5D shows an example inter-slot frequency hopping pattern 530 usable for broadcast DL transmissions according to some implementations. The inter-slot frequency hopping pattern 530 may be used for PDSCH with repetition by using slot-specific frequency hopping offsets. As shown, a DCI message may signal or trigger the DL transmission of SIB1 for SSB0 using an example four different frequency hopping channels 531-534 that do not overlap in time or frequency. In some implementations, the broadcast information may include SIB1, and each frequency hopping offset may be based on a size of a common control resource set with index 0 (CORESET #0) allocated to the PDSCH. In some other implementations, the broadcast information may include one or more of a paging signal or a random access response (RAR), and each frequency hopping offset may be configured by a SIB carried on the PDSCH. In addition, or in the alternative, the slot-specific frequency hopping offsets may include a first frequency hopping offset for even-numbered slots of the number of identified slots, and may include a second frequency hopping offset for odd-numbered slots of the number of identified slots.

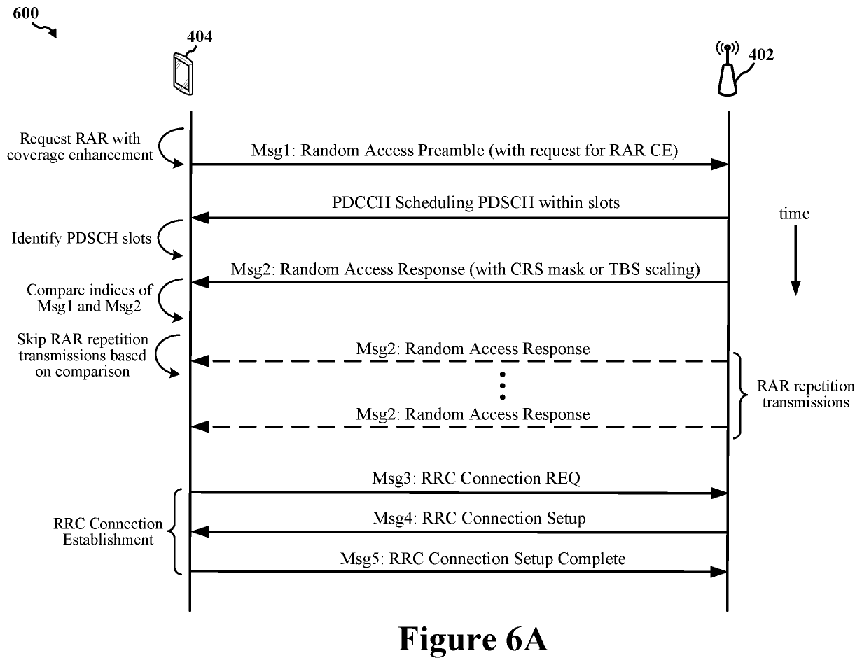

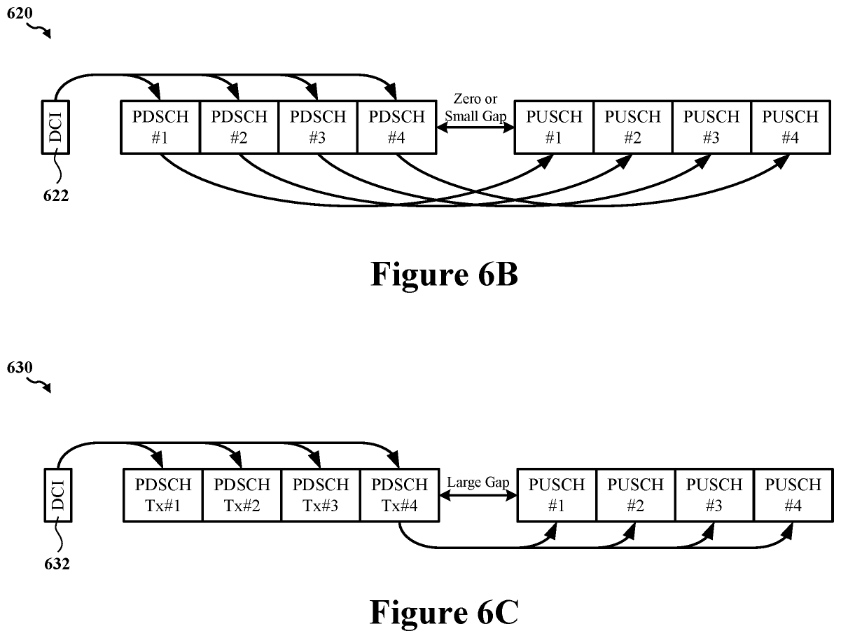

FIG. 6A shows a sequence diagram illustrating an example message exchange 600 between a base station 402 and a UE 404 in a radio access network (RAN). The base station 402 may be one example of the base station 102 of FIG. 1 or the base station 310 of FIG. 3, and the UE 404 may be one example of the UE 104 of FIG. 1 or the UE 350 of FIG. 3. The base station 402 may be any suitable base station or node including, for example, a gNB or an eNB. The RAN may be any suitable radio access network, and may employ any suitable radio access technology.

The UE 404 may use a random access procedure to establish a layer-1 (physical layer) and layer-2 (MAC layer) connection with the base station 402, and then use an RRC procedure to establish a layer-3 connection (such as an RRC connection) with the base station 402. As shown in FIG. 6A, the UE 404 transmits a random access preamble as Msg1 to the base station 402 on a random access channel (RACH). The random access preamble include a randomly or pseudo-randomly selected preamble sequence. In some implementations, the selection of the preamble sequence may indicate a request by the UE for coverage enhancement (CE) associated with transmission of the random access response (RAR) on the PDSCH. In some aspects, the UE may transmit a random access preamble requesting RAR coverage enhancement when an SSB-based reference signal received power (RSRP) level is less than a value (such as indicating that RAR repetition may be needed for the UE to receive and correctly decode the RAR). In some other implementations, the base station may determine that the UE is capable of receiving the RAR on the PDSCH with repetition based on the UE's reported capabilities. In some instances, the RACH may be a contention-based UL channel, and in other instances, the RACH may be a contention-free UL channel.

In some implementations, the base station 402 may transmit a physical downlink control channel (PDCCH) that schedules a PDSCH within a number of consecutive slots, and then transmit the RAR containing a random access preamble identifier as Msg2 in one or more slots of the number of consecutive slots of the PDSCH. In some instances, the PDSCH may be associated with a transport block size (TBS) scaling factor of one-eighth, for example, to effectively reduce the MCS of the PDSCH transmission for coverage enhancement. In some other instances, the PDSCH carrying the RAR may be associated with a TBS scaling factor of other values (such as larger than one-eighth), and the coverage enhancement may be achieved by repetitive transmission of the RAR in a number of the consecutive slots of the PDSCH.

In some implementations, the base station may indicate whether the RAR is transmitted with or without repetition, for example, so that the UE can determine whether coverage enhancement is provided for the RAR. In some instances, the base station may distinguish between RAR transmissions with coverage enhancement and RAR transmissions without coverage enhancement using the PDCCH's CRC mask (such as based on different RA-RNTIs used for the PDCCH with coverage enhancement and without coverage enhancement). In other instances, the base station may distinguish between RAR transmissions with coverage enhancement and RAR transmissions without coverage enhancement using a bit (such as the MSB) of the MCS field in the DCI message. In some other instances, the base station may distinguish between RAR transmissions with coverage enhancement and RAR transmissions without coverage enhancement using an additional CRC mask for a number of MSBs of the CRC parity bits. For example, the base station may use an 8-bit mask to scramble the 8 MSBs of the CRC parity bits based on the expression:

cₖ=(bₖx_{mask,k-A})mod 2 for k=A, . . . ,A+7

and cₖ=(bₖ+x_{RNTI,k-A-8})mod 2 for k=A+8,A+9, . . . ,A+23,

where bₖ is the sequence after CRC attachment, cₖ is the sequence after CRC scrambling, and x_{(mask,k-A)} is the 8-bit mask defined in Table 1:

TABLE 1

| <x₀, x₁, . . . , x₇> | 8-bit mask |
|---|---|
| RAR with coverage enhancement | <0, 0, 0, 0, 0, 0, 0, 0> |
| RAR without coverage enhancement | <0, 0, 0, 0, 0, 0, 0, 1> |

The UE 404 receives the RAR in one or more slots of the PDSCH, and determines whether the random access preamble identifier contained in Msg2 matches the preamble sequence that was transmitted to the base station 402 in Msg1. When there is a match, the UE 404 may initiate an RRC connection establishment procedure. When there is not a match, the UE 404 may continue monitoring the PDSCH (such as one or more subsequent slots of the PDSCH identified by the PDCCH.

In some implementations, the UE 404 may skip decoding the RAR in the one or more subsequent slots of the PDSCH when an index of the random access preamble identifier contained in Msg2 matches the index of the random access preamble sequence contained in Msg1. In some instances, the UE 404 may refrain from decoding the RAR in subsequent slots when the index of the random access preamble identifier is larger than the index of the random access preamble sequence. In other instances, the UE 404 may refrain from decoding the RAR in subsequent slots when the index of the random access preamble identifier is in a different group than the index of the random access preamble sequence.

The UE 404 may transmit an RRC connection request as Msg3 to the base station 402. The RRC connection request may contain a UE identity (UEID) that uniquely identifies the UE 404. The base station 402 receives Msg3, and may use the UE identity to retrieve the UE's context and capabilities from an associated core network entity. In some instances, the base station 402 may use the UE's radio capability information to determine an initial signaling radio bearer (SRB1) configuration for the UE 404. The base station 402 may transmit the SRB1 configuration to the UE 404 in an RRC connection setup message as Msg4. The UE 404 receives Msg4, determines its SRB1 configuration, and transmits an RRC connection setup complete message as Msg5 to the base station 402. Reception of Msg5 by the base station 402 may conclude the RRC connection establishment procedure.

In some implementations, the base station 402 may transmit a physical downlink control channel (PDCCH) that schedules a PDSCH within a number of consecutive slots, and then transmits the RAR (Msg2) in one or more slots of the number of consecutive slots of the PDSCH. In some instances, each slot of the number of consecutive slots of the PDSCH may be associated with a different transport block (TB), and transmission of the RRC connection setup message (Msg3) may be initiated based on a last symbol period in the slot of the PDSCH carrying the RAR. In some other implementations, the number of consecutive slots of the PDSCH may be aggregated slots associated with the same TB, and transmission of the RRC connection setup message (Msg3) may be initiated based on a last symbol period of the aggregated slots.

FIG. 6B shows an illustration 620 depicting an example scheduling of multiple transport blocks usable for broadcast DL transmissions according to some implementations. Referring also to FIG. 6A, a DCI message 622 may be transmitted to a UE on a DL channel (such as the PDCCH) to schedule multiple PDSCHs carrying RARs (Msg2) in consecutive slots of the same PDCCH. In such implementations, the start of the Msg3 transmission may be based on the last symbol of the corresponding PDSCH slot. In some instances, each of the number of consecutive slots of the PDSCH may be associated with a different transport block (TB) and different RARs.

FIG. 6C shows an illustration 630 depicting an example scheduling of repetition slots usable for broadcast DL transmissions according to some implementations. Referring also to FIG. 6A, a DCI message 632 may be transmitted to a UE on a DL channel (such as the PDCCH) to schedule the PDSCH carrying RARs with slot aggregation or repetition. In such implementations, the start of the Msg3 transmission may be based on the last symbol of the corresponding PDSCH repetition transmission slot. In some instances, the number of consecutive slots of the PDSCH are aggregated slots associated with the same transport block (TB) and the same RARs.

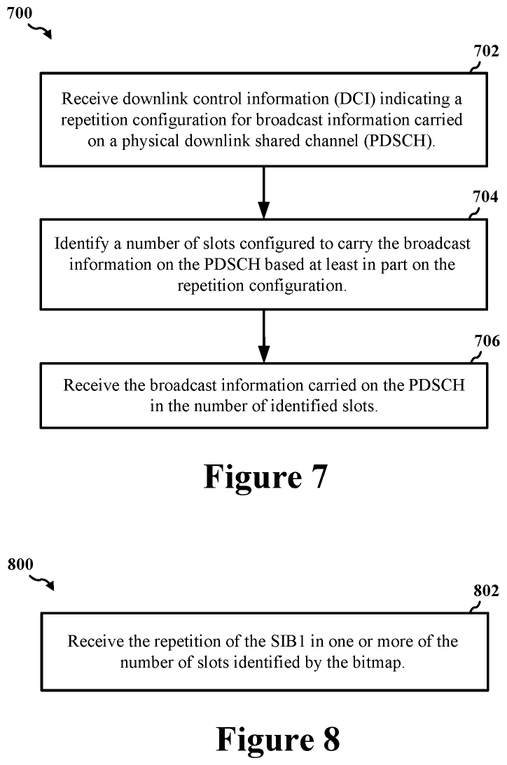

FIG. 7 shows a flowchart depicting an example operation 700 for wireless communication that supports repetition of broadcast information. The operation 700 may be performed by a wireless communication device such as the UE 104 of FIG. 1, the UE 350 of FIG. 3, or the UE 404 of FIG. 4A. At block 702, the UE receives downlink control information (DCI) indicating a repetition configuration for broadcast information carried on a physical downlink shared channel (PDSCH). At block 704, the UE identifies a number of slots configured to carry the broadcast information on the PDSCH based at least in part on the repetition configuration. At block 706, the UE receives the broadcast information carried on the PDSCH in the number of identified slots.

The repetition configuration may indicate or identify a number of slots configured for repetition transmission of the broadcast information. In some implementations, the broadcast information may include a first system information block (SIB1), and the repetition configuration may include a bitmap identifying slots within a transmission period of the SIB1 that are available for repetition. The bitmap may include a number N of bits, with each bit of the N bits indicating a corresponding slot of N slots available for repetition transmission. In some implementations, the UE 404 may receive the SIB1 in one or more of the repetition slots identified by the bitmap. In some instances, the bitmap may be replicated one or more times to identify one or more additional sets of N slots available for repetition transmissions of the SIB1. In other instances, only the first M slots of the available slots are used for repetition transmissions, where the value of M may be based on the number of available slots.

FIG. 8 shows a flowchart depicting an example operation 800 for wireless communication that supports repetition of broadcast information. The operation 800 may be performed by a wireless communication device such as the UE 104 of FIG. 1, the UE 350 of FIG. 3, or the UE 404 of FIG. 4A. In some implementations, the example operation 800 may be performed at least partially concurrently with receiving the broadcast information on the PDSCH in block 706 of the operation 700 of FIG. 7. At block 802, the UE receives the repetition of the SIB1 in one or more of the number of slots identified by the bitmap. In some implementations, the bitmap may be replicated one or more times to identify one or more additional sets of N slots available for repetition transmissions.

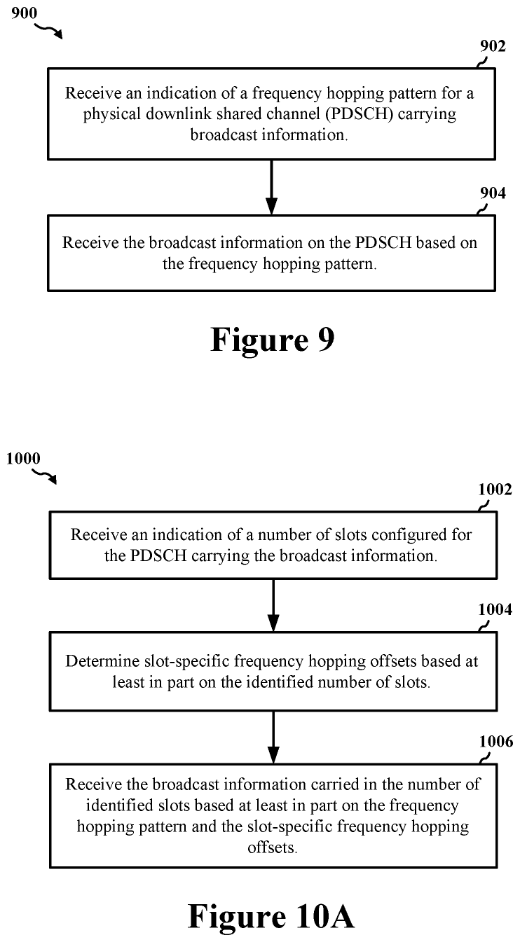

FIG. 9 shows a flowchart depicting an example operation for wireless communication that supports frequency hopping on a broadcast PDSCH. The operation 800 may be performed by a wireless communication device such as the UE 104 of FIG. 1, the UE 350 of FIG. 3, or the UE 404 of FIG. 5A. At block 902, the UE receives an indication of a frequency hopping pattern for a physical downlink shared channel (PDSCH) carrying broadcast information. At block 904, the UE receives the broadcast information on the PDSCH based on the frequency hopping pattern.

In some implementations, the broadcast information may include a first system information block (SIB1), and each frequency hopping offset of the number of frequency hopping offsets may be based on a size of a common control resource set with index 0 (CORESET #0) allocated to the PDSCH. In some other implementations, the broadcast information may include one or more of a paging signal or a random access response (RAR), and each frequency hopping offset of the number of frequency hopping offsets may be configured by a SIB carried on the PDSCH. In addition, or in the alternative, the indication may identify a number of frequency hopping offsets for the frequency hopping pattern.

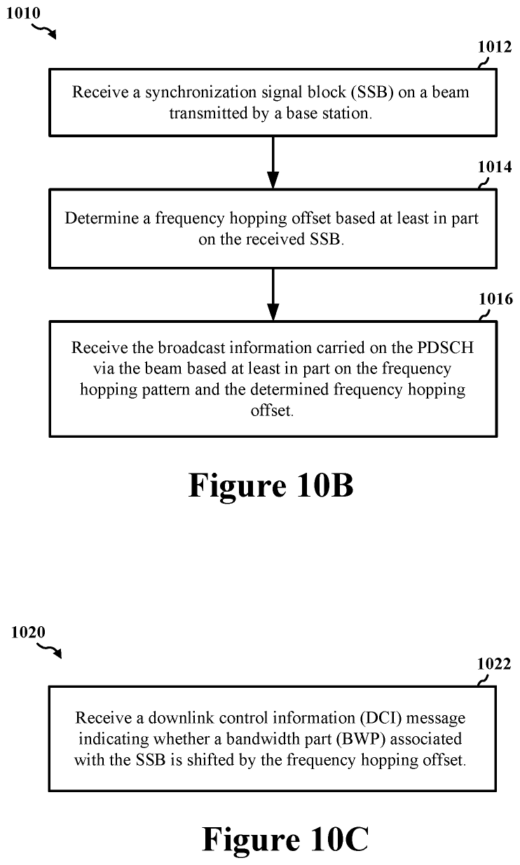

FIG. 10A shows a flowchart depicting an example operation 1000 for wireless communication that supports frequency hopping on a broadcast PDSCH. The operation 1000 may be performed by a wireless communication device such as the UE 104 of FIG. 1, the UE 350 of FIG. 3, or the UE 404 of FIG. 5A. In some implementations, the example operation 1000 may be performed before receiving the broadcast information in block 904 of the operation 900 of FIG. 9. In other implementations, the example operation 1000 may be performed separately from the operation 900 of FIG. 9. At block 1002, the UE receives an indication of a number of slots configured for the PDSCH carrying the broadcast information. At block 1004, the UE determines slot-specific frequency hopping offsets based at least in part on the identified number of slots. At block 1006, the UE receives the broadcast information carried in the number of identified slots based at least in part on the frequency hopping pattern and the slot-specific frequency hopping offsets.

In some implementations, the slot-specific frequency hopping offsets may include a first frequency hopping offset for even-numbered slots of the number of identified slots, and may include a second frequency hopping offset for odd-numbered slots of the number of identified slots. In some aspects, the indication may be received in a downlink control information (DCI) message.

FIG. 10B shows a flowchart depicting an example operation 1010 for wireless communication that supports frequency hopping on a downlink channel carrying broadcast information. The operation 1010 may be performed by a wireless communication device such as the UE 104 of FIG. 1, the UE 350 of FIG. 3, or the UE 404 of FIG. 5A. In some implementations, the example operation 1010 may be performed before receiving the broadcast information in block 904 of the operation 900 of FIG. 9. In other implementations, the example operation 1010 may be performed separately from the operation 900 of FIG. 9. At block 1012, the UE receives a synchronization signal block (SSB) on a beam transmitted by a base station. At block 1014, the UE determines a frequency hopping offset based at least in part on the received SSB. At block 1016, the UE receives the broadcast information carried on the PDSCH via the beam based at least in part on the frequency hopping pattern and the determined frequency hopping offset.

In some implementations, the frequency hopping offset may be semi-statically configured via radio resource control (RRC) signaling. The RRC signaling may indicate a mapping between a plurality of beams associated with the base station and a number of frequency hopping offsets, and may indicate a mapping between each beam of the plurality of beams and a corresponding SSB of a plurality of SSBs.

FIG. 10C shows a flowchart depicting an example operation 1020 for wireless communication that supports frequency hopping on a downlink channel carrying broadcast information. The operation 1020 may be performed by a wireless communication device such as the UE 104 of FIG. 1, the UE 350 of FIG. 3, or the UE 404 of FIG. 5A. In some implementations, the example operation 1020 may be performed before receiving the broadcast information in block 904 of the operation 900 of FIG. 9. In other implementations, the example operation 1020 may be performed separately from the operation 900 of FIG. 9. At block 1022, the UE receives a downlink control information (DCI) message indicating whether a bandwidth part (BWP) associated with the SSB is shifted by the frequency hopping offset.

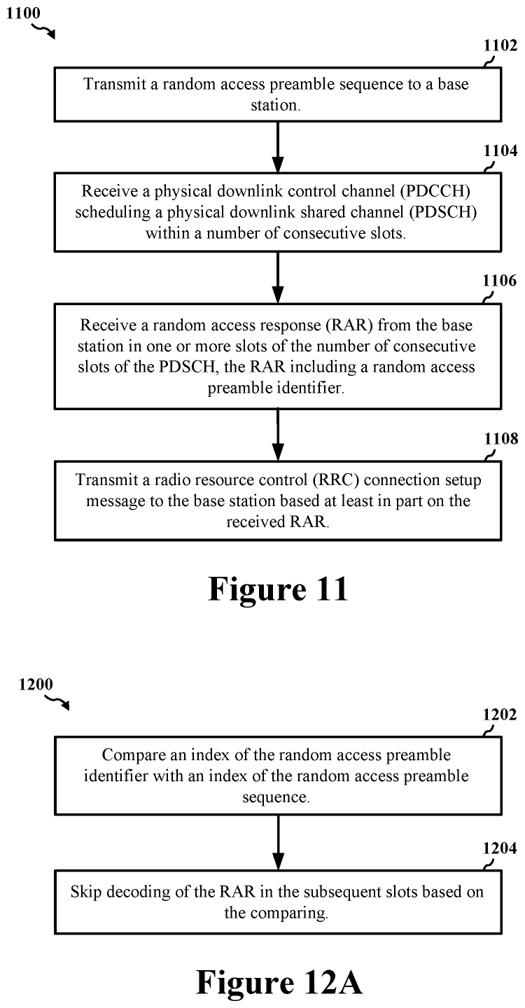

FIG. 11 shows a flowchart depicting an example operation 1100 for wireless communication that supports repetition transmissions for a random access procedure. The operation 1100 may be performed by a wireless communication device such as the UE 104 of FIG. 1, the UE 350 of FIG. 3, or the UE 404 of FIG. 6A. At block 1102, the UE transmits a random access preamble sequence to a base station. At block 1104, the UE receives a physical downlink control channel (PDCCH) scheduling a physical downlink shared channel (PDSCH) within a number of consecutive slots. At block 1106, the UE receives a random access response (RAR) from the base station in one or more slots of the number of consecutive slots of the PDSCH, the RAR including a random access preamble identifier. At block 1108, the UE transmits a radio resource control (RRC) connection setup message to the base station based at least in part on the received RAR.

In some implementations, each of the number of consecutive slots of the PDSCH may be associated with a different transport block (TB), and a start of the RRC connection setup message transmission may be based on a last symbol period in the slot of the PDSCH carrying the RAR. In some other implementations, the number of consecutive slots of the PDSCH may be aggregated slots associated with the same TB, and a start of the RRC connection setup message transmission may be based on a last symbol period of the aggregated slots.

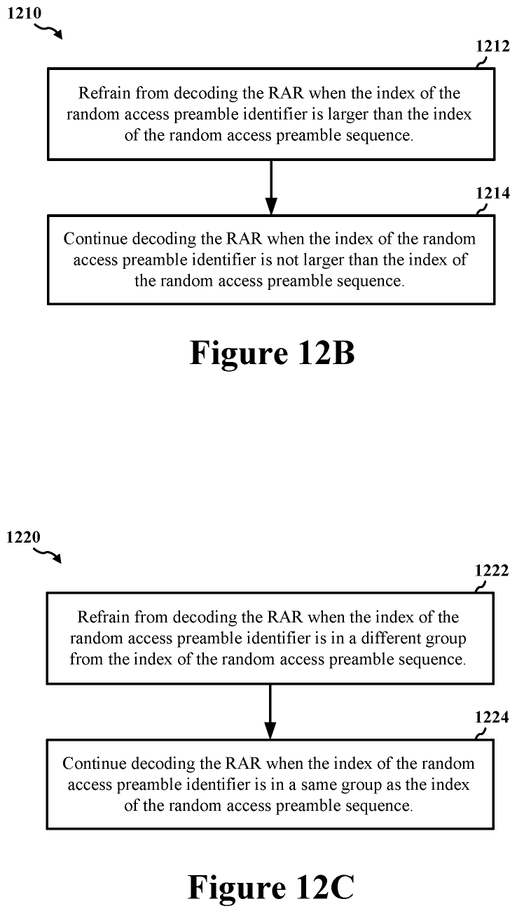

FIG. 12A shows a flowchart depicting an example operation 1200 for wireless communication that supports repetition transmissions for a random access procedure. The operation 1200 may be performed by a wireless communication device such as the UE 104 of FIG. 1, the UE 350 of FIG. 3, or the UE 404 of FIG. 6A. In some implementations, the example operation 1200 may be performed after receiving the RAR in block 1104 of the operation 1100 of FIG. 11. At block 1202, the UE compares an index of the random access preamble identifier with an index of the random access preamble sequence. At block 1204, the UE skips decoding the RAR in the subsequent slots based on the comparing.

FIG. 12B shows a flowchart depicting an example operation 1210 for wireless communication that supports repetition transmissions for a random access procedure. The operation 1210 may be performed by a wireless communication device such as the UE 104 of FIG. 1, the UE 350 of FIG. 3, or the UE 404 of FIG. 6A. In some implementations, the example operation 1210 may be one example of skipping decoding of the RAR in block 1204 of the operation 1200 of FIG. 12A. At block 1212, the UE refrains from decoding the RAR when the index of the random access preamble identifier is larger than the index of the random access preamble sequence. At block 1214, the UE continues decoding the RAR when the index of the random access preamble identifier is not larger than the index of the random access preamble sequence.

FIG. 12C shows a flowchart depicting an example operation 1220 for wireless communication that supports repetition transmissions for a random access procedure. The operation 1220 may be performed by a wireless communication device such as the UE 104 of FIG. 1, the UE 350 of FIG. 3, or the UE 404 of FIG. 6A. In some implementations, the example operation 1220 may be one example of skipping the decoding of the RAR in block 1204 of the operation 1200 of FIG. 12A. At block 1222, the UE refrains from decoding the RAR when the index of the random access preamble identifier is in a different group from the index of the random access preamble sequence. At block 1224, the UE continues decoding the RAR when the index of the random access preamble identifier is in a same group as the index of the random access preamble sequence.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices (such as a combination of a DSP and a microprocessor), a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. A method for wireless communication performed by a user equipment (UE), comprising:
receiving downlink control information (DCI) indicating a repetition configuration for broadcast information carried on a physical downlink shared channel (PDSCH);
identifying a number of slots configured to carry the broadcast information on the PDSCH based at least in part on the repetition configuration; and
receiving the broadcast information carried on the PDSCH in the number of identified slots.

2. The method of claim 1, wherein the number of slots available for repetition is based at least in part on a modulation and coding scheme (MCS) used by the UE or a group of UEs including the UE.

3. The method of claim 1, wherein the broadcast information includes a first system information block (SIB1), and the repetition configuration indicates a bitmap identifying a number of slots within a transmission period of the SIB1 that are available for repetition.

4. The method of claim 3, further comprising:
receiving the SIB1 in one or more of the number of slots within the transmission period of the SIB1 that are available for repetition.

5. The method of claim 3, wherein the bitmap includes N bits, each bit of the N bits indicating a corresponding slot of N slots available for repetition transmissions, wherein N is an integer greater than one.

6. The method of claim 5, wherein the bitmap is replicated one or more times to identify one or more additional sets of N slots available for repetition transmissions of the SIB1.

7. The method of claim 5, wherein only a first M slots of the available slots are used for repetition transmissions, wherein M is an integer less than N, wherein a value of M is based at least in part on the number of available slots.

8. (canceled)

9. A method for wireless communication performed by a user equipment (UE), comprising:
receiving an indication of a frequency hopping pattern for a physical downlink shared channel (PDSCH) carrying broadcast information; and
receiving the broadcast information on the PDSCH based at least in part on the frequency hopping pattern.

10. The method of claim 9, wherein the indication identifies a number of frequency hopping offsets for the frequency hopping pattern.

11. The method of claim 10, wherein the broadcast information includes a first system information block (SIB1), and each frequency hopping offset of the number of frequency hopping offsets is based at least in part on a size of a common control resource set with index 0 (CORESET #0) allocated to the PDSCH.

12. The method of claim 10, wherein the broadcast information includes one or more of a paging signal or a random access response (RAR), and each frequency hopping offset of the number of frequency hopping offsets is configured by a system information block (SIB) carried on the PDSCH.

13. The method of claim 8, further comprising:
receiving an indication of a number of slots configured for the PDSCH carrying the broadcast information;
determining slot-specific frequency hopping offsets based at least in part on the indicated number of slots; and
receiving the broadcast information carried in the indicated number of slots based at least in part on the frequency hopping pattern and the slot-specific frequency hopping offsets.

14. The method of claim 13, wherein the slot-specific frequency hopping offsets include a first frequency hopping offset for even-numbered slots of the indicated number of slots, and include a second frequency hopping offset for odd-numbered slots of the indicated number of slots.

15. (canceled)

16. The method of claim 9, further comprising:
receiving a synchronization signal block (SSB) on a beam transmitted by a base station;
determining a frequency hopping offset based at least in part on the received SSB; and
receiving the broadcast information carried on the PDSCH via the beam based at least in part on the frequency hopping pattern and the determined frequency hopping offset.

17. The method of claim 16, wherein the frequency hopping offset is semi-statically configured via radio resource control (RRC) signaling that indicates a mapping between a plurality of beams associated with the base station and a number of frequency hopping offsets.

18. (canceled)

19. The method of claim 18, wherein at least some beams of the plurality of beams have different frequency hopping offsets.

20. The method of claim 16, further comprising:
receiving a downlink control information (DCI) message indicating whether a bandwidth part (BWP) associated with the SSB is shifted by the frequency hopping offset.

21. A method for wireless communication performed by a user equipment (UE), comprising:
transmitting a random access preamble sequence to a base station;
receiving a physical downlink control channel (PDCCH) scheduling a physical downlink shared channel (PDSCH) within a number of consecutive slots;
receiving a random access response (RAR) from the base station in one or more slots of the number of consecutive slots of the PDSCH, the RAR including a random access preamble identifier; and
transmitting a radio resource control (RRC) connection setup message to the base station based at least in part on the received RAR.

22. (canceled)

23. The method of claim 21, wherein the random access preamble sequence indicates a request for RAR coverage enhancement.

24. The method of claim 23, wherein the request for RAR coverage enhancement is based at least in part on a reference signal received power (RSRP) level being less than a value.

25. (canceled)

26. The method of claim 21, wherein each of the number of consecutive slots of the PDSCH is associated with a different transport block (TB).

27. The method of claim 22, wherein a start of the RRC connection setup message is based at least in part on a last symbol period in the slot of the PDSCH carrying the RAR.

28. The method of claim 21, wherein the number of consecutive slots of the PDSCH comprise aggregated slots associated with the same transport block (TB).

29. The method of claim 28, wherein a start of the RRC connection setup message is based at least in part on a last symbol period of the aggregated slots.

30. The method of claim 21, further comprising:
skipping a decoding of the RAR in the subsequent slots based at least in part on comparing an index of the random access preamble identifier with an index of the random access preamble sequence.

31. The method of claim 26, wherein the skipping comprises:
refraining from decoding the RAR when the index of the random access preamble identifier is larger than the index of the random access preamble sequence; and
continuing decoding the RAR when the index of the random access preamble identifier is not larger than the index of the random access preamble sequence.

32. The method of claim 26, wherein the skipping comprises:
refraining from decoding the RAR when the index of the random access preamble identifier is in a different group from the index of the random access preamble sequence; and
continuing decoding the RAR when the index of the random access preamble identifier is in a same group as the index of the random access preamble sequence.

33-35. (canceled)
